(19) United States
(12) Patent Application Publication
(10) Pub. No.: US 2026/0216786 A1
(43) Pub. Date: Jul. 30, 2026

(54) COPPER POWDER

(71) Applicant: JX Advanced Metals Corporation, Minato-ku, Tokyo (JP)

(72) Inventor: Reina Tsuchihashi, Ibaraki (JP)

(21) Appl. No.: 19/149,067

(22) PCT Filed: Nov. 21, 2023
(86) PCT No.: PCT/JP2023/041858

§ 371 Date: Jul. 17, 2025

(30) Foreign Application Priority Data
Mar. 23, 2023 (JP) 2023-047112

(51) Int. Cl. B22F 1/05; B22F 9/24; C09D 5/24; C09D 7/61; C09D 7/63; H01B 1/02

(52) U.S. Cl. CPC B22F 1/05; B22F 9/24; C09D 5/24; C09D 7/61; C09D 7/63; H01B 1/02; B22F 2301/10

(57) ABSTRACT

A copper powder has an average reflectance ΔY of 0.3% or more.

### TECHNICAL FIELD

This specification discloses a technique for copper powder.

### BACKGROUND ART

In recent years, attention has focused on forming conductive films by mixing copper powder with an ink or paste to make a conductive coating material, applying the material and then heating it to sinter the copper powder. This allows for the rapid formation of desirable patterned conductive films at a relatively low cost.

To form a fine pattern of a conductive film with such a method, fine copper powder is used as the copper powder to be contained in the conductive coating material. However, due to high surface activity of the fine copper powder, the copper particles that make up the copper powder tend to be agglomerated with each other in the conductive coating material, leading to a reduced yield in the production of conductive coating materials.

In relation to this, Patent Literature 1 aims for “providing a method for producing copper powder that can obtain a copper powder with little variation in particle diameter and improved monodispersity”, and proposes “a method for producing copper powder, the method comprising preparing a copper complex ion solution from a copper-containing solution and a complexing agent, and then adding a reducing agent to the copper complex ion solution to precipitate metal copper”.

### CITATION LIST

### Patent Literature

[PTL 1] Japanese Patent Application Publication No. H9-241709 A

### SUMMARY OF INVENTION

### Technical Problem

As described above, from the viewpoint of improvement of the yield and the like, there is a need for a copper powder that is difficult to be agglomerated and easily dispersed in conductive coating materials. The copper powder produced by the method described in Patent Literature 1 is not sufficiently high dispersibility.

This specification provides a copper powder having improved dispersibility.

### Solution to Problem

The copper powder disclosed in this specification has an average reflectance AY of 0.3% or more.

### Advantageous Effects of Invention

The above copper powder has improved dispersibility.

### BRIEF DESCRIPTION OF DRAWINGS

FIG. 1 is a photograph of a membrane filter after suction filtration when the average reflectance AY of copper powders according to Example 2 and Comparative Example 1 was measured.

### DESCRIPTION OF EMBODIMENTS

Hereinafter, embodiments of the copper powder as described above will be described in detail.

The copper powder according to an embodiment has an average reflectance AY of 0.3% or more. This is based on the new finding that the dispersibility of the copper powder in the conductive coating material is improved when the average reflectance AY is 0.3% or more, although the reason is not necessarily clear.

### (Composition)

The copper powder contains copper (Cu) and is mostly composed of copper. The containing of copper in the copper powder can be confirmed by X-ray diffraction (XRD).

The copper content of the copper powder excluding copper oxide may be, for example, 98% by mass or more, typically 99.5% by mass or more. The copper content is measured by X-ray diffraction (XRD).

The copper powder may contain citric acid (C₆H₈O₇). For example, the copper powder containing citric acid due to the addition of citric acid during production tends to have a shape close to sphere, and as the contact area between copper particles becomes smaller, aggregation is more easily suppressed.

The containing of citric acid in the copper powder can be confirmed by identification using a liquid chromatography-Orbitrap mass spectrometer (Thermo Fisher Scientific, LC-Orbitrap MS, LC: Vanquish Analytical Purification LC System, Orbitrap MS: Orbitrap Exploris 240 mass spectrometer). The measurement conditions are as follows. The copper powder is added to a mixed solution of an aqueous 10 mmol/L ammonium acetate solution and acetonitrile (at volume ratio of 1:1) (4 mL of mixed solution per 1 g of copper powder), extracted using a shaker and an ultrasonic cleaner, separated into a copper powder and an extract by centrifugation, and then filtered using a syringe filter (Millex (registered trademark)-LCR, manufactured by Merck Millipore, material: hydrophilic PTFE, pore size: 0.45 μm) to collect an extract. The extract is measured with the liquid chromatography-Orbitrap mass spectrometer as described above. Hypersil GOLD (C18) is used for the column, the mobile phase is introduced to change from 10 mmol/L of aqueous ammonium acetate solution to acetonitrile, and the column temperature can be 40° C. In the negative ion detection mode, if a value (+0.5) close to the m/z value of 191.0192 (the monoisotopic mass of [C₆H₈O₇—H]—, which is the chemical formula corresponding to citric acid from which a proton has been released), is detected, it can be said that the copper powder contains citric acid.

### (Average Reflectance)

The copper powder has an average reflectance AY of 0.3% or more. If the average reflectance AY of the copper powder is 0.3% or more, the copper powder is less likely to be agglomerated in the conductive coating material and is sufficiently dispersed. It is desirable that the average reflectance AY is higher from the viewpoint of improving dispersibility, and it is preferably 0.7% or more, and more preferably 1.8% or more. The average reflectance AY of the copper powder may be 20% or less.

The average reflectance AY of the copper powder is measured as follows:

First, a sample is prepared. More specifically, the copper powder is mixed with water to form a slurry, and a moisture content of the slurry is adjusted to 94 to 97% by mass. At this time, a container containing the slurry including the copper powder is shaken to make the slurry uniform. More specifically, 50 g to 80 g of the slurry is placed in a cylindrical 100 mL polyethylene container with a lid, the lid is closed, and the the container is shaken up and down at a frequency of at least 25 times per 10 seconds for 3 to 5 minutes. The slurry containing the copper powder is then subjected to suction filtration through MF-Millipore membrane filter having a diameter of 47 mm and a pore diameter of 0.025 μm from Merck so that the copper filter on the filter is 0.3 g±0.05 g. When performing the suction filtration, the slurry is dropped on the filter so that a liquid pool is formed thereon, and suction is then carried out using a suction pump (ULVAC DTU-20) without touching it until the liquid recedes. At this time, the suction is carried out until no liquid can be visually confirmed. The copper powder is thereby deposited evenly and without bias on the filter. The filter after suction filtration is then dried in the air atmosphere for at least 3 hours. This results in a deposited layer of the copper powder on the filter. The filter is attached onto a flat glass plate so that it does not lift up, and this is used as a sample.

The reflectance Y value is then measured for the above sample. As a measurement device, SQ 7700 (NIPPON DENSHOKU INDUSTRIES Co., Ltd.) can be used. Here, the measurement is performed with the sample placed face-down so that the hole in the measuring portion of the device is completely blocked. The reason why the sample is placed face-down is because the above measurement device has a structure which is irradiated with light from the lower side to the upper side. This allows the reflectance Y value to be measured. Detailed conditions are given below:
Calibration: white standard plate attached to the SQ 7700 (NIPPON DENSHOKU INDUSTRIES Co., Ltd.) is used;
Illumination and light-receiving conditions: di: 8° and de: 8° in accordance with JIS Z8722;
Light source: D65;
Viewing angle: 10°;
Measuring diameter: 18 mm; and
Color coordinate system: reflectance Y value is measured.

Each Y value (spectral reflectance) in the XYZ color coordinate system for each of the SCI method including the positive reflected light and the SCE method excluding the positive reflected light is measured by the method described above, and the average reflectance AY is calculated from ΔY=(Y value for SCI method)−(Y value for SCE method).

### (BET Specific Surface Area)

The BET specific surface area of the copper powder is preferably 1.0 m²/g to 15.0 m²/g. If the BET specific surface area is less than 1.0 m²/g, there is a concern that the copper powder may not be sintered by heating it at a relatively low temperature, or that fine wiring may not be achieved by the conductive film. If the BET specific surface area is more than 15.0 m²/g, it will be difficult to ensure oxidation resistance of the copper powder, and there is concern that moisture absorption and the like may affect properties of the conductive coating material.

From such a point of view, the BET specific surface area of the copper powder is preferably 2.0 m²/g to 10.0 m²/g, and more preferably 3.0 m²/g to 7.0 m²/g.

The BET specific surface area of the copper powder can be measured according to JIS Z8830: 2013, for example, using BELSORP-mini II from Microtrac Bell. More specifically, 3 g of a sample of the copper powder is degassed in a vacuum of absolute pressure of 10 Pa at 70° C. for 5 hours, and a nitrogen adsorption isotherm is then measured by a static capacitance method, and the obtained results are analyzed by the BET method to calculate the BET specific surface area.

### (Roughness of Deposited Layer)

When the slurry containing the copper powder is dried to form a deposited layer of the copper powder, an arithmetic mean roughness Ra on the surface of the deposited layer is preferably 2.0 μm or less. If the arithmetic mean roughness Ra is 2.0 μm or less, the copper powder would have sufficiently high dispersibility, and the conductive coating material obtained with such copper powder would tend to have effectively dispersed copper powder.

From the viewpoint of further improving dispersibility, it is suitable that the arithmetic mean roughness Ra of the deposited layer of the copper powder is further 1.5 μm or less, especially 1.2 μm or less. There is no particular disadvantage if this arithmetic mean roughness Ra is too low, but it may be 0.1 μm or more for the purpose of production.

For the same reason as the arithmetic mean roughness Ra, the maximum height Rz of the deposited layer of the copper powder is preferably 10 μm or less, even 8 μm or less, and it may be 1.0 μm or more.

To measure the above arithmetic mean roughness Ra and maximum height Rz, the slurry is prepared, suction filter and drying are performed by the same methods as those of the above measurement of the mean reflectance AY, and a filter with the deposited layer of the copper powder formed is attached to a glass plate to prepare a sample. The surface texture of the sample is measured in accordance with JIS B0601: 2001, and the arithmetic mean roughness Ra and maximum height Rz are determined. As the measurement device, OPTELICS HYBRID (Lasertec Corporation; “OPTELICS” is a registered trademark) can be used. Three points are measured under the following measurement conditions, and an average value thereof is determined to be the measurement result.
Analysis software: LMeye7;
Lens name: TU Plan Apo 50×/0.80 A (Nikon Corporation);
Magnifications: 50×;
Resolution: 0.07 μm;
Light path: confocal;
Scanning rate: standard;
Operation mode: standard;
Percent magnification: 100%;
Gain: 200;
Exposure time: standard;
Room temperature: 20 to 25° C.;
λs: 0.0025 mm;
λc: 0.8000 mm;
λf: 2.500 mm;
Lc: 0.8 mm;
Tilt correction: auto;
Captured area: 296.532 μm×296.532 μm (1024 pixels×1024 pixels); and
Analysis range: 200 μm×200 μm (690 pixels×690 pixels).

### (Production Method)

Various methods such as chemical reduction, disproportionation, and other liquid phase methods can be employed to produce the copper powder. For example, in the case of the liquid phase method, it is important to add a predetermined amount of citric acid and adjust the amount of citric acid added in predetermined periods of time. A specific example of the production method in the case where the chemical reduction method is used will be described below in detail.

In the chemical reduction method, copper salts such as copper sulfate, a reducing agent, and an alkali are mixed and caused to react in a liquid to produce copper particles and a copper slurry containing copper particles. The reducing agent includes hydrazine, hydrazine monohydrate, 1,1-dimethylhydrazine, 1,2-dimethylhydrazine, sodium sulfite, sodium borohydride, sodium hydrogen sulfite, hypophosphite, sodium hypophosphite, ascorbic acid, oxalic acid, formic acid, formaldehyde, and the like. The alkali includes sodium hydroxide, ammonia, potassium hydroxide, and others. A pH adjusting agent such as dilute sulfuric acid or citric acid may also be used as needed.

In one more detailed example, an aqueous copper sulfate solution is heated to an appropriate reaction temperature, and a pH is then adjusted with a sodium hydroxide or an aqueous ammonia solution, and the reaction is then performed by adding hydrazine solution all at once to reduce the copper sulfate to cuprous oxide particles having a particle diameter of about 100 nm. After the cuprous oxide slurry containing cuprous oxide particles is heated to the reaction temperature, the cuprous oxide particles are reduced to copper particles by dropping an aqueous solution containing sodium hydroxide and hydrazine, followed by an aqueous hydrazine solution.

In the above method, it is preferable to add 20 g to 30 g of citric acid per 50 g of copper powder to be finally produced when generating cuprous oxide particles. Citric acid is also added to stop the nucleation of copper particles after the nuclei have been formed, and an amount of citric acid added is preferably 2 g to 5 g per 50 g of copper powder to be finally produced. For the amount of citric acid added at any period of time, an excessively low amount tends to result in a copper powder with no luster and a lower average reflectance AY. On the other hand, if an amount of citric acid added is too high at least in one period of time, it may not be reduced to copper. In this case, the finally produced copper powder will contain cuprous oxide or copper hydroxide, which may result in a copper powder with no luster and a lower average reflectance AY. In addition, increasing the amount of alkali such as hydrazine and sodium hydroxide in order to reduce copper as the amount of citric acid added increases will increase the cost of waste liquid treatment. If the amount of sodium hydroxide is increased, the sodium content of the copper powder increases, and short circuits are more likely to occur when fine wiring is formed using such copper powder.

After obtaining the copper slurry containing the copper particles as described above, it can be washed with a filter press or decantation, or the like to separate solid and liquid, dried and crushed to provide a copper powder.

### EXAMPLES

Next, the copper powder as described above was experimentally produced and the effects thereof were confirmed, as described below. However, descriptions herein are merely for illustration, and are not intended to be limited thereto.

### Example 1

200 g of copper sulfate pentahydrate and 25 g of citric acid were dissolved in 725 g of water, and the liquid temperature was raised above 50° C. To this was added a mixed solution of 800 g of an aqueous 10 wt % sodium hydroxide solution, 100 g of water, and 12 g of hydrazine monohydrate. This is believed that cuprous oxide particles were thereby produced. A mixed solution of 20 g of an aqueous 10 wt % sodium hydroxide solution and 6 g of hydrazine monohydrate was added. Then, 10.8 g of an aqueous 10 wt % sodium hydroxide solution was added. At this time, nucleation of copper particles would be generated. Then, 2.5 g of citric acid dissolved in 20 g of water was added. It is assumed that the generation of copper particle nuclei was thereby stopped. Subsequently, an aqueous solution of 6 g of hydrazine monohydrate and 100 g of water was added and stirred for 2 hours to attempt to grow nuclei of copper particles. At the end of the reaction, decantation was repeated and washed with water to obtain a copper powder.

### Example 2

200 g of copper sulfate pentahydrate and 25 g of citric acid were dissolved in 725 g of water, and the liquid temperature was raised above 50° C. To this was added a mixed solution of 800 g of an aqueous 10 wt % sodium hydroxide solution, 100 g of water, and 12 g of hydrazine monohydrate. A mixed solution of 20 g of an aqueous 10 wt % sodium hydroxide solution and 6 g of hydrazine monohydrate was then added. Then, 10.6 g of an aqueous 10 wt % sodium hydroxide solution was added. Then, 2.5 g of citric acid dissolved in 20 g of water was added. Subsequently, an aqueous solution of 6 g of hydrazine monohydrate and 100 g of water was added, and the mixture was stirred for 2 hours. At the end of the reaction, decantation was repeated and washed with water to obtain a copper powder.

### Example 3

200 g of copper sulfate pentahydrate and 25 g of citric acid were dissolved in 725 g of water, and the liquid temperature was raised above 50° C. To this was added a mixed solution of 820 g of an aqueous 10 wt % sodium hydroxide solution, 100 g of water, and 18 g of hydrazine monohydrate. Then, 2.5 g of citric acid dissolved in 20 g of water was added. Subsequently, an aqueous solution of 6 g of hydrazine monohydrate and 100 g of water was added, and the mixture was stirred for 1 hours. At the end of the reaction, decantation was repeated and washed with water to obtain a copper powder.

### Example 4

Based on the production method according to Example 1, a copper powder was produced by changing the reducing agent, pH adjusting agent, and stirring time until cuprous oxide was reduced to copper powder.

### Comparative Example 1

200 g of copper sulfate pentahydrate and 2.5 g of citric acid were dissolved in 725 g of water, and the liquid temperature was set to 50° C.

To this was added 450 g of an aqueous 10 wt % sodium hydroxide solution. A mixed solution of 100 g of water and 12 g of hydrazine monohydrate was then added. After the addition, the liquid temperature was raised above 50° C. and a mixed solution of 210 g of an aqueous 10 wt % sodium hydroxide solution and 1.2 g of hydrazine monohydrate was added. Then, 40.0 g of an aqueous 10 wt % sodium hydroxide solution was added. Then, 2.5 g of citric acid dissolved in 20 g of water was added. Subsequently, an aqueous solution of 6 g of hydrazine monohydrate and 100 g of water was added, and the mixture was stirred for 3 hours. At the end of the reaction, decantation was repeated and washed with water to obtain a copper powder.

### Comparative Example 2

200 g of copper sulfate pentahydrate and 2.5 g of citric acid were dissolved in 725 g of water, and the liquid temperature was set to 50° C.

To this was added a mixed solution of 450 g of an aqueous 10 wt % sodium hydroxide solution, 100 g of water, and 12 g of hydrazine monohydrate. After stirring, the liquid temperature was raised to 70° C. Subsequently, a mixed solution of 210 g of an aqueous 10 wt % sodium hydroxide solution and 6 g of hydrazine monohydrate was added and stirred for 5 minutes after addition. Then, 35.0 g of an aqueous 10 wt % sodium hydroxide solution was added and stirred for 5 minutes after addition. After stirring, 2.5 g of citric acid dissolved in 20 g of water was added, and the mixture was stirred for 5 minutes after addition. Subsequently, an aqueous solution of 6 g of hydrazine monohydrate and 100 g of water was added in 2 minutes and 30 seconds, and the mixture was stirred for 1 hour.

### Evaluation

The BET specific surface area, average reflectance AY, and arithmetic mean roughness Ra of the deposited layer were measured for each copper powder obtained in Examples 1 to 4 and Comparative Examples 1 and 2 according to the previously described method. These results shown in Table 1. In Table 1, the BET diameter was calculated using BET specific surface area SSA and true density p from the following equation: BET diameter=6/(ρ×SSA). The p was 8.96 g/cm³. The roughness Rz is the value obtained for the maximum height using the same method as the above measurement method for the arithmetic mean roughness Ra of the deposited layer.

The copper powders obtained in Comparative Examples 1 and 2 would have a smaller average reflectance AY than the copper powders obtained in Examples 1 to 4, due to the smaller amount of citric acid added when the cuprous oxide particles were formed.

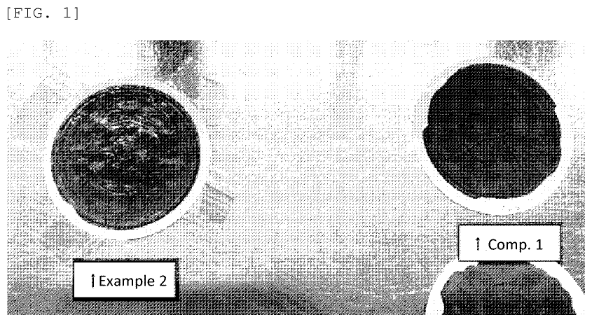

For reference, FIG. 1 shows a photograph of the membrane filter after suction filtration when the average reflectance AY of each copper powder according to Example 2 and Comparative Example 1 was measured. It is found from FIG. 1 that the copper powder according to Example 2 has a metallic luster, whereas the copper powder according to Comparative Example 1 does not have a metallic luster. Further, although photographs are omitted, the copper powders according to Examples 1, 3 and 4 had a metallic luster like the copper powder according to Example 2, whereas the copper powder according to Comparative Example 2 did not have a metallic luster like the copper powder according to Comparative Example 1.

In addition, conductive coating materials were prepared using the copper powders according to Examples 1 to 4 and Comparative Examples 1 and 2, and their viscosities were confirmed. Specific procedure is as follows.

In Examples 1 and 2 and Comparative Example 1, a-terpineol (80.5 g), oleic acid (6.5 g), and ethyl cellulose (49% ethoxy) 10 (13.0 g) were mixed in a planetary centrifugal mixer and it was used as vehicle. The vehicle (2.0 g) and copper powder (8.0 g) were mixed in the planetary centrifugal mixer to obtain a conductive coating material.

In Example 3 and Comparative Example 2, a-terpineol (80.5 g), oleic acid (6.5 g), and ethyl cellulose (49% ethoxy) 10 (13.0 g) were mixed in the planetary centrifugal mixer and it was used as vehicle. The vehicle (2.0 g), copper powder (8.0 g), and α-terpineol (0.6 g) were placed in a 100 ml vessel and mixed in a planetary centrifugal mixer (THNKY, ARE-310) at 2000 rpm for 5 minutes to obtain a conductive coating material.

The viscosity of the conductive coating material prepared as described above was measured using MCR 102 rotational viscometer from Anton Paar. More specifically, the conductive coating material was placed on a constant temperature plate set at 25° C., a cone plate (model number: CP 25-2) at a cone angle of 2° was used as a measurement jig, a gap setting at the measurement position was set to 0.1 mm, and the cone plate was pressed against the conductive coating material, and the conductive coating material that protruded from the cone plate was then removed. The measurement program gradually increased the shear rate from 0 to 1000 s⁻¹ over a time period of 392 seconds. The paste viscosity at each shear rate was thereby measured. The viscosities at shear rates of 1 s⁻¹ and 10 s⁻¹ are shown in Table 1.

TABLE 1

| | | BET | Average | | | | |
|---|---|---|---|---|---|---|---|
| | BET | Diameter | Reflectance | Roughness | Roughness | Viscosity [Pa*s] | |
| | [m²/g] | [nm] | Δγ [%] | Ra [μm] | Rz [μm] | 1 [1/s] | 10 [1/s] |
| Example 1 | 4.4 | 152 | 9.60 | 0.90 | 4.00 | 373 | 190 |
| Example 2 | 3.2 | 209 | 1.96 | 0.43 | 2.43 | 311 | 154 |
| Example 3 | 6.81 | 98 | 6.20 | 1.00 | 4.64 | 374 | 156 |
| Example 4 | 10.2 | 66 | 0.40 | 1.16 | 7.31 | Not measurable | |
| Comparative Example 1 | 2.04 | 328 | 0.02 | 4.51 | 19.89 | 1833 | 786 |
| Comparative Example 2 | 5.75 | 117 | 0.02 | 6.99 | 31.35 | 995 | 396 |

It is found from Table 1 that the copper powders according to Examples 1 to 4 all have the increased average reflectance AY and an equally smaller roughness Ra (and Rz) of the deposited layer of the copper powder, as compared with the copper powders according to Comparative Examples 1 and 2. This indicates that as the average reflectance AY is higher, the roughness tends to decrease.

The copper powders according to Examples 1 to 3, which have a larger average reflectance AY, have a lower viscosity of the conductive coating material than the copper powders according to Comparative Examples 1 and 2. It is believed that the larger the average reflectance AY, in other words, the smaller the roughness of the deposited layer of copper powder, the lower the viscosity of the conductive coating material. Here, the lower viscosity of the conductive coating material indicates that the copper powder is highly dispersible in the conductive coating material. Therefore, it can be said that the copper powders according to Examples 1 to 4 have higher dispersibility than those in Comparative Examples 1 and 2.

In addition, since the copper powder according to Example 4 had a lower BET diameter, the copper powder was oxidized to generate heat during the preparation of the conductive coating material, causing it to be aggregated, and any conductive dispersion could not be prepared, and as a result, it was not possible to measure the viscosity. However, this is a matter of handling, and it is believed that a conductive coating material can be produced by taking measures such as working in an inert atmosphere (for example, a nitrogen atmosphere), and so on. The copper powder according to Example 4 also has sufficiently low roughness Ra and Rz as compared to the copper powders according to Comparative Examples 1 and 2, and also achieves one indicator, roughness Ra of 2.0 μm or less. Therefore, there is a high probability that the viscosity of the conductive coating material made with the copper powder according to Example 4 will also be sufficiently low. Specifically, the viscosity of the conductive coating material made with copper powder according to Example 4 is expected to be the viscosity between Comparative Example 2 and Example 1, and to be closer to that of Example 1 than Comparative Example 2.

These results suggest that the copper powder described above may have improved dispersibility.

1. A copper powder having an average reflectance ΔY of 0.3% or more.

2. The copper powder according to claim 1, wherein the copper powder has a BET specific surface area of 1.0 m²/g to 15.0 m²/g.

3. The copper powder according to claim 1, wherein an arithmetic mean roughness Ra of a deposited layer of the copper powder obtained by drying a slurry containing the copper powder is 2.0 μm or less.

4. The copper powder according to claim 1, wherein the copper powder contains citric acid.
